(19) United States
(12) Patent Application Publication
(10) Pub. No.: US 2012/0166941 A1
(43) Pub. Date: Jun. 28, 2012

(54) CONTENT PROCESSING WITH EXTENSIBILITY

(75) Inventors: Armando Marin, Redmond, WA (US); Yusuf Atas, Redmond, WA (US); Scott Hysom, Issaquah, WA (US); Kevin Brown, Woodinville, WA (US)

(73) Assignee: MICROSOFT CORPORATION, Redmond, WA (US)

(21) Appl. No.: 12/978,454

(22) Filed: Dec. 24, 2010

(51) Int. Cl. G06F 17/00

(52) U.S. Cl. 715/255

(57) ABSTRACT

A content generation system may allow for extensions that can modify or influence the content that is being generated, while allowing the extensions to run separately from the base content generator. In one example, a processing engine converts raw data into presentable content (e.g., HTML content that is visually-presentable on a high-quality web site). The processing engine may be extensible in the sense that it may allow extension components to interact with the processing engine, or to modify the output of the processing engine, in order to influence the nature of the generated content. For example, if the processing engine uses certain parameters to produce a banner, then an extension may cause the banner to be rotated, re-sized, re-colored, etc. The extension may execute in an isolated space, thereby allowing code of arbitrary provenance to execute without destabilizing the processing engine or the server on which the processing engine runs.

### BACKGROUND

Content publishing systems, such as the software that drives web sites, generally have a processing component that turns raw documents into a presentable piece of content. For example, raw data may specify certain text and images. The processing component may lay out the text in a certain font and color, and may place the images in certain locations on the page.

Processing components are normally built and specialized for a particular type of presentation. A problem with such components is that it is difficult to extend them to handle additional content elements or different presentations. Extending the capabilities of such component generally involves modifying the component itself. Such modifications may affect the stability of the processing component, since the programmer who makes the modification may be unfamiliar with the processing component software that he or she is modifying.

### SUMMARY

The capabilities of a content-processing component may be extended, without direct modification to the content-processing component itself. In one example, a processing component creates presentations of content using raw data. For example, raw data might be used to specify the content for a page on a commercial web site. An example of such raw data is data that specifies a banner with the text “This is a banner,” along with a particular photo. The processing component may create a Hypertext Markup Language (HTML) page that presents a banner, with the specified text and photo, in a form that is visually eye-pleasing and/or compatible with the general look-and-feel of the web site. The processing component may interact with extensions that modify, in some way, the content that the processing component creates. For example, the extension might turn a banner into a rotating banner (e.g., a banner that rotates through several different views), or an enlarged banner, or perform some other operation on the banner. The extension may operate on the final content produced by the processing component, or it may interact with the processing component during the content-creation process, in order to influence the way in which the processing component presents the content.

An extension may be a code module that is written to implement a specific extension. Or, as another example, an extension may be a package that can perform various actions based on a set of supplied parameters. Such a package might implement functions such as rotate, enlarge, etc., and could accept parameters to determine, for example, whether to turn a particular piece of content into rotating content (e.g., content that cycles through several views), whether to enlarge the content, how much to enlarge, etc. Regardless of the form that the extension takes, the extension may provide a manifest that describes how the content-processing component is to interact with the extension. Such a manifest may specify that the extension operate on the content-processing component at various points during the content-generation process, thereby allowing the extension to influence, in various ways, the nature of the content that is being created. In general, extension modules are deployed on the servers on which they execute, in the sense that the deployment follows a set of engineering-driven actions. On the other hand, packages may be published—i.e., packages may be made available on a server without reinstalling the server and/or following the prescribed deployment actions.

The extension may execute in an environment that is isolated from the environment in which the content-processing component itself executes. The isolation may be hardware-enforced (e.g., the isolated environment may reside on a separate machine), or may be implemented through software (e.g., an isolated process may execute on the same machine as the other processes from which it is being isolated, but may execute in a protected space). In this way, the extension is prevented from affecting the stability of the content-processing component itself. Thus, extensions can be created by people who are unfamiliar with the content-processing component and/or whose programming skill level is unknown, without risking the stability of the content-processing component.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which extensions may be used to affect content.

FIG. 2 is a block diagram of an example system in which content may be processed using extensions.

FIG. 3 is a flow diagram of an example process that may be used to generate content and to apply an extension.

FIG. 4 is a block diagram of example components that may be used in connection with implementations of the subject matter described herein.

### DETAILED DESCRIPTION

Electronic content publishing systems, such as the servers and software that drive web sites, often generate content by taking some raw information and converting it to a presentable format. For example, a web site may take some text (raw information), and may put the text into an HTML file along with specifications of the appropriate font, color, size, layout, etc. As a more complicated example, a web site might allow a content creator to specify individual elements of a web page (e.g., banners, button, input fields, etc.), where the content-processing engine of the web site puts these elements in the appropriate format. Allowing content creators to specify information in a raw form, while using a processing engine to put the content into an appropriate form for presentation, serves various goals. It may simplify the creation of presentable content, by allowing the content creator to focus on the content without having to be concerned with the details of the presentation. Additionally, it may encourage uniformity among web pages—e.g., an enterprise may have many individual content creators, but may want to present all of their content in a uniform format as part of the site's branding.

As a typical example, a banner for a web page might contain a heading, an image, some text, a submit button (with customizable text), etc. Thus, the processing engine for such a web site might expose a function called “Banner” which takes these parameters as input. Thus, a content creator might be able to specify a banner with an instruction such as “Banner(“My Heading”, image.jpg, “This is some text”, “To submit, click here!”, . . . )”. (The foregoing is an example format for such an instruction, although the instruction could take any form.) The processing engine would then create a page that includes the specified banner in the appropriate format for the web site.

The ability to specify content in the manner described above presumes that a set of functions, such as the “Banner” function, exist. These functions may be written by programmers for the enterprise that operates the web site, based on graphic schemes chosen by the web site's graphic designers. A problem with this type of scheme, however, is that once the processing engine has been written, it is hard to modify its behavior. For example, a Banner function might produce a single, fixed banner. If the content creator wants to show such a banner, then the function can be used to produce what the creator wants to show. But if the content creator wants to create a rotating banner—e.g., a banner that rotates through several views of content—the function may not be able to produce such a rotated banner.

In theory, the processing engine can be modified to produce content with a different presentation. However, modifying the processing engine involves giving content creators access to the processing engine's code. Programmers who want to modify the behavior of the processing engine might not be familiar with the code, and the skill level of these programmers may be unknown. If the processing engine resides on a web server and is in a stable state, modifications to the processing engine could crash the server. In a web server environment, a crashed server may result in loss of traffic, and therefore a possible loss of revenue generated from that traffic.

The subject matter described herein allows a content-generation process to be extended, without modifying the main content generation component. In a content publishing scenario (such as a web server that generates pages to be served to clients), a processing engine converts raw content into a form that is appropriate for presentation. An extension may be applied to the processing engine in order to modify the presentable content produced by the processing engine. For example, the extension might change the appearance by rotating among different content items, re-sizing the content, skewing the content, animating the content, skewing the content, etc. The extension provides an interface that allows the processing engine to interact with the extension at various points in the content generation process. The extension may describe these interaction points through a manifest file. Thus, with reference to the banner example above, the processing engine might invoke the extension once when processing the banner text, another time when processing the image, another time when applying colors, etc., based on the interaction points specified in the manifest.

Extensions may be implemented in various ways. In one example, the extension comprises a code module that is written to implement a specific extension. In another example, the extension takes the form of an extensibility package, which acts as a kind of interpreter of rules or instructions. Code modules may be installed as part of a deployment, while extensibility packages may be published. Deployments generally are performed according to a set of engineering driven actions—e.g., a new version of server software may be “deployed” by performing a full install of the new version on the machine on which it is going to run. An extension module could be part of such a deployment, but—because of the overhead involved in a deployment—deployments may not occur that frequently. On the other hand, an extensibility package can be published, without having to reinstall a machine's full set of software, and without otherwise having to go through the actions for a deployment. Extension modules and extensibility packages may behave similarly, but differ in in the way they are made available (e.g., deployment versus publishing).

For example, rotation among different content items might be a common function to be performed on content. Thus, an extensibility package might implement the rotation function, so that one who wants to rotate content could simply issue a specification that instructs the package to rotate among several content items, in which case the extensibility package interprets the instruction. Using extensibility packages in this way allows a broadly applicable extension solution to be created, which can be used by content creators or content providers in a wide variety of circumstances. (In one example, the extensibility package, and the set of rules that the package interprets, are provided by distinct entities—e.g., a commercial software provider might provide the extensibility package and publish its capabilities, while a person who uses that software to administer a web site might write the rules or instructions that the package interprets.)

Extensions may operate in an isolated environment (or “sandbox”) to prevent the extension from affecting the stability of the underlying content generator. In one example, the processing engine runs on a back-end server, the extension runs on a middle tier (which may implement the extension as a form of “middleware”), and web content is served by a plurality of front-end servers. With the underlying processing engine running on a back-end server and the extension running elsewhere, the extension is effectively isolated from the environment in which the processing engine runs, as well as the front-end servers that actually provide content to users. In this way, instability in the extension would not threaten to bring down the web server functionality. However, it will be understood that implementing a sandbox does not necessarily involve running the sandboxed software on a separate machine. In another example, an extension that is to be isolated from other software components could run in a protected space on the same machine as those other components. Thus, the sandbox could be implemented either using hardware-based isolation or software-based isolation.

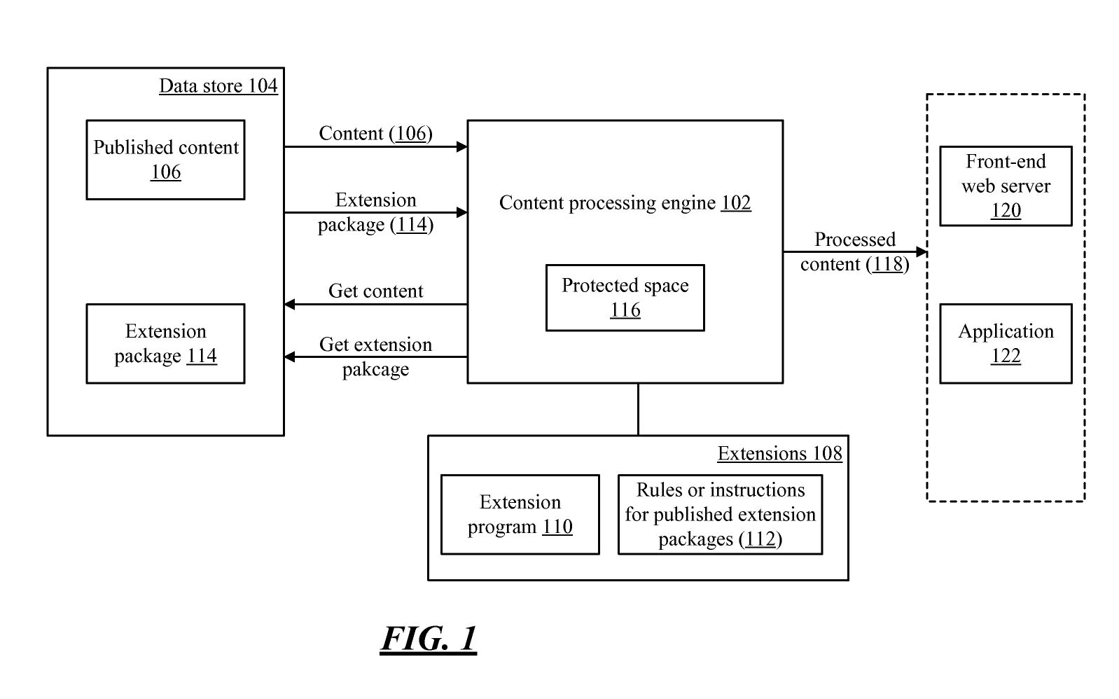

Turning now to the drawings, FIG. 1 shows an example scenario in which extensions may be used to affect content. Content processing engine 102 generates content in a presentable form based on raw data. For example, content processing engine 102 may receive instructions such as “Banner(“Heading”, cat.jpg, “Text”, “Button Text”, . . . )” (which is an example of raw data), and may convert this type of instruction into the HTML code to produce a web page that contains a banner that has the specific parameters, but with a particular appearance. Content processing engine 102 may receive the raw data from data store 104. Data store 104 may contain published content 106 (which may, for example, be in the raw data form described above).

Additionally, content processing engine 102 may allow extensions 108 to affect the process of generating presentable content. Extensions 108 may take various forms. One type of extension is an extension program 110 (or “module”), which comprises code that is written to implement a specific type of extension, and that may be deployed as part of a software installation. For example, a content creator or provider may want to perform highly customized operations on content, and thus may write an extension from scratch in order to implement these customized operations. Such an extension is an example of extension program 110. Another example of extensions 108 is a set of rules or instructions 112 for use with a published extension package 114. As noted above, a published extension may be made available without having to undergo a full “deployment” process. As mentioned above, an extension package may implement various common types of operations, such as rotation, re-sizing, etc., and specific operations can be invoked through a set of rules or instructions 112. The published extension package 114 may be stored in data store 104, and may be retrieved, or otherwise accessed, by content processing engine 102 when the package is to be used. In such an example, the extension takes the form of the rules or instructions 112 that tell the extension package 114 what sort of operations to perform to affect the content-generation process.

In one example, content processing engine provides, or otherwise makes use of, a protected space 116, in order to securely isolate the processes performed by extensions 108 from the general processes that are otherwise performed by content processing engine 102. Protected space 116 may be referred to as a “sandbox”, and may be implemented in various ways. For example, as alluded to above, processing engine 102 may execute on a back-end server, and extensions may execute in a middle tier. Thus, the middle tier is an example of a protected space that isolates a processing engine from an extension, thereby reducing the chance that an unstable extension will affect the stability of the processing engine and/or the server on which the processing engine runs. In general, extensions may be said to execute in a protected space when they execute outside of the content processing engine and/or the server on which it runs, since doing so meets the goal of protecting the stability of the processing engine and/or the server from the uncertain stability of the extension. However, running an extension on a separate machine such as a “middle tier” machine is merely one example of a sandbox implementation, since isolation does not have to be hardware-based. In another example, an extension runs on the same machine as the code form which the extension is to be isolated, but runs in a protected space.

Content processing engine 102 produces processed content 118. Processed content 118 is the result of converting raw content into presentable content, but with extensions 108 having been applied. Thus, if content processing engine 102 is configured to perform a content-generation process that produces a banner, and if extensions 108 are configured to affect the creation of the banner in some way (e.g., rotation among different views, re-sizing, color change, etc.), the result of the content-generation process is processed content 118 (or, more precisely, processed content 118 is the content that results after the content-generation process and/or the content that it produces has undergone the modifications called for by the extensions).

Once processed content 118 has been created, it may be provided to any entity that could make use of that content. For example, processed content 118 may be provided to front end web server 120, so that it may be served to users or other entities that request the content through the web. In another example, processed content 118 may be provided to an application 122, which may use the content in some manner, so that the content can later be consumed. For example, application 122 might use processed content 118 as a building block in a larger web page (or other type of content experience), which could be provided to users.

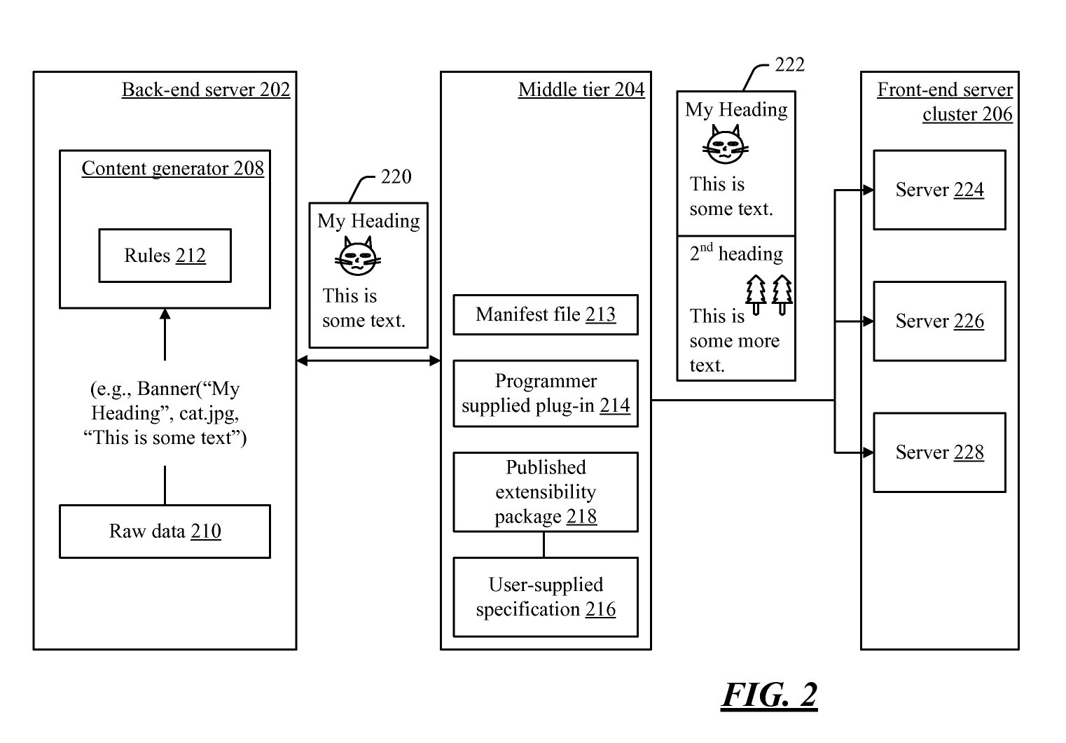

FIG. 2 shows the structure of an example system in which content may be processed using extensions. The subject matter described herein is not limited to the structure shown. However, FIG. 2 shows an example of such a structure.

In the example of FIG. 2, there is a back-end server 202, a middle tier 204, and a front-end server cluster 206. This structure might be used, for example, to implement a web site, where clients communicate directly with machines in a front-end cluster, but certain preparation of content is performed on machines that are further back in the structure.

Back-end server 202 may comprise a content generator 208. Content generator 208 may be a program that generates content based on raw data 210 and rules 212. Content generator 208 may, for example, implement the idea, previously discussed, that a content creator may create content in a raw form, and a processing engine re-casts that content into a form that is presentable for publication (e.g., publication on the web). Thus, as in the prior example, the raw data might be an instruction of the form “Banner(“My Heading”, cat.jpg, “This is some text”, “To submit, click here!”, . . . )”. Content generator 208 may produce the HTML code to show this banner in a format this is visually-pleasing and/or meets certain style guidelines associated with a particular web site. Content generator 208 is an example of the content processing engine discussed above in connection with FIG. 1.

Middle tier 204 may be an environment in which extensions can execute, so that the extensions can interact with content generator 208 and/or with the content generated by content generator 208. Those extensions may provide a manifest file 213, which describes the interaction points at which such interaction is to take place. For example, if content generator 208 is composing a banner, it may be able to allow an extension to influence various parts of the process—e.g., the color, the size, the location of an image within the banner, the final layout, etc. Manifest file 213 may specify those points at which an extension will interact with the content-generation process, so that the extension can perform some operation on the content and/or influence some aspect of the creation of the content.

As noted above, extensions may take various forms. Thus FIG. 2 shows two types of extensions operating in the environment provided at middle tier 204. In one example, an extension takes the form of a programmer-supplied plug-in 214 or “module”, which a programmer has written in order to implement a particular type of extension to content. Such a programmer-supplied plug-in 214 may be deployed to execute on middle tier 204, and it will be noted that—by executing in the environment provided by middle tier 204—the plug-in's execution is isolated from that of the content generator 208 itself and the back-end server 202 on which content generator 208 operates (although, as noted above, executing on a separate machine is not the only way that an extension can be isolated from other programs). Since programmer-supplied plug-in 214 may be written by a programmer of unknown motives and/or skill, this type of isolation protects the stability of content generator 208 and back-end server 202 from code that might affect that stability. In another example, the extension takes the form of a user-supplied specification 216 of rules or instructions to be carried out by a published extensibility package 218. As noted above, such a published extensibility package 218 may be able to implement a variety of operations that can be performed on content and/or that can influence the content-generation process. As also noted above, since the extensibility package is published, it may be possible to make extensibility packages available more frequently (and to change existing extensibility packages more frequently) than would be possible with a deployed plug-in or module.

In the example of FIG. 2, the extension (whatever form it might take) implements rotation among different views. Thus, content generator 208 (acting without any influence from the extension) would produce one or more banners such as banner 220. Due to the influence of the extension, the result is banner 222, which includes several views that rotate in the same banner. (In the example shown, there are two views through which banner rotates—one containing a cat, the other containing trees. However, a rotating banner could rotate through any number of views.) (It is noted that extensions are reusable—e.g., if an extension exists to produce a rotated banner, then it may be usable to rotate some other type of content element.)

When the techniques used herein are used to create content to be published on the web, then the extended content (i.e., the content produced as a result of applying one or more extensions, such as rotating banner 222) may be provided to a front-end server cluster 206. The cluster may contain a plurality of servers, such as servers 224, 226, and 228 shown in FIG. 2. These servers may serve web content (including extended content, such as the rotated banner 222 shown in the figure) to entities (e.g., users, applications, etc.) that request the content.

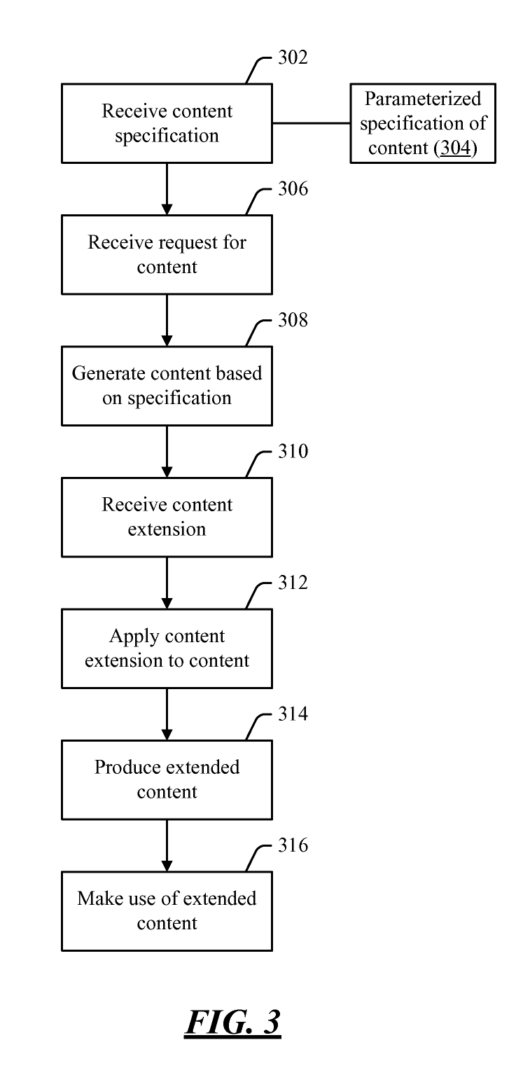

FIG. 3 shows, in the form of a flow chart, an example process that may be used to generate content and to apply an extension. Before turning to a description of FIG. 3, it is noted that FIG. 3 is described, by way of example, with reference to components shown in FIGS. 1 and 2, although the process of FIG. 3 may be carried out in any system and is not limited to the scenarios shown in FIGS. 1 and 2. Additionally, the flow diagram of FIG. 3 shows an example in which stages of a process are carried out in a particular order, as indicated by the lines connecting the blocks, but the various stages shown in this diagram can be performed in any order, or in any combination or sub-combination.

At 302, a specification or description of content may be received. The specification of content may constitute the raw data mentioned above, and may, for example, take the form of a parameterized specification of a content element (block 304). The example of a banner that is specified as “Banner(“My Heading”, cat.jpg, . . . ” is an example of a parameterized specification of a content element, although the specification of content could take any form.

At 306, a request may be received for content. For example, a client may connect to a front-end web server in order to request content that is served by the web server. At 308, content may be generated based on the specification mentioned above.

At 310, a content extension is received. As described above, the content extension may take the form of a programmer-supplied plug-in, or a set of rules and/or instructions to be carried out by an extension package. At 312, the extension may be applied to the content.

FIG. 3 shows the actions at 306-312 taking place in a particular sequence. However, these actions may take place in a different sequence, and the actions shown toward the bottom of the drawing do not necessarily occur in response to the actions shown near the top. For example, while FIG. 3 shows content being generated after the request for content is received, the content might be generated by a back-end server (with the content being modified by the extensions described herein) before the content actually has been requested by a client, and the back-end server might push this content out to a front-end server cluster in anticipation that clients will request the content. Moreover, FIG. 3 shows content extensions being applied after content has been generated, but extensions can be applied concurrently with the generation of the content—that is to say, the extensions can interact with the content-generation process.

The result of the foregoing actions is to produce extended content (at 314). Extended content, as used herein, refers to the content that is produced when an extension is applied to and/or influences the content-generation process. At 316, the extended content may be used. For example, the extended content may be (or may be part of) a web page that is tangibly communicated to clients, and or the content may be stored for later use.

The following are some example aspects of the subject matter described herein.

Decoupling of the processing workflow and the specialized processing logic: In the design of a general purpose content processing system the common steps and stages that make up the processing workflows may be decoupled from the implementation of a particular type of processing. Such a system can be easily extended to provide a new type of processing (e.g. support a new presentation element) by adding a new module that contains the extensions that are specific to the new task.

Multi-targeting capability: By having a system that is designed to be a separate entity from the presentation application (i.e. the website), the functionality of the system as a whole may be leveraged by multiple end-points (i.e., consuming applications). The system can have rules that define how to process a particular type of content for different end-points, while reusing common components. For example, suppose content X defines a table of prices, extension a can produce HTML output, and extension β can produce XML Paper Specification (XPS) output. The system can be configured to process the same content differently for each of the endpoints. For example, site 1 calls for content X, then the system uses extension a to process it, thus providing an HTML representation of the price table. Then, site 2 calls for content X, and the system uses extension β to process it, thus providing an XPS representation of the price table.

Component re-use: A system designed in accordance with the subject matter herein may have the ability to use the product of each “processing unit” as a building block to create more complex outputs. For example, extension γ may convert content written in an author friendly markup into blocks of HTML. Doing so serves the original purpose of the site and the front-end uses these “blocks” to put the pages together. The site owners may want to enhance their property by creating a new presentation element that allows certain blocks of HTML to be hidden by the user. Thus, extension λ may be written with the purpose of providing an HTML container that allows its content to be hidden. For the actual content that is hosted inside this container one would not need to re-write the logic from extension γ, or even know any of its implementation details. Extension λ can leverage the content processing system and request that the contained content be processed by extension γ. In this sense, extensions λ and γ may be nested. Each nested extension may get its own processing workflow and does not need to expose its functionality to the caller (which, in this example, is extension λ).

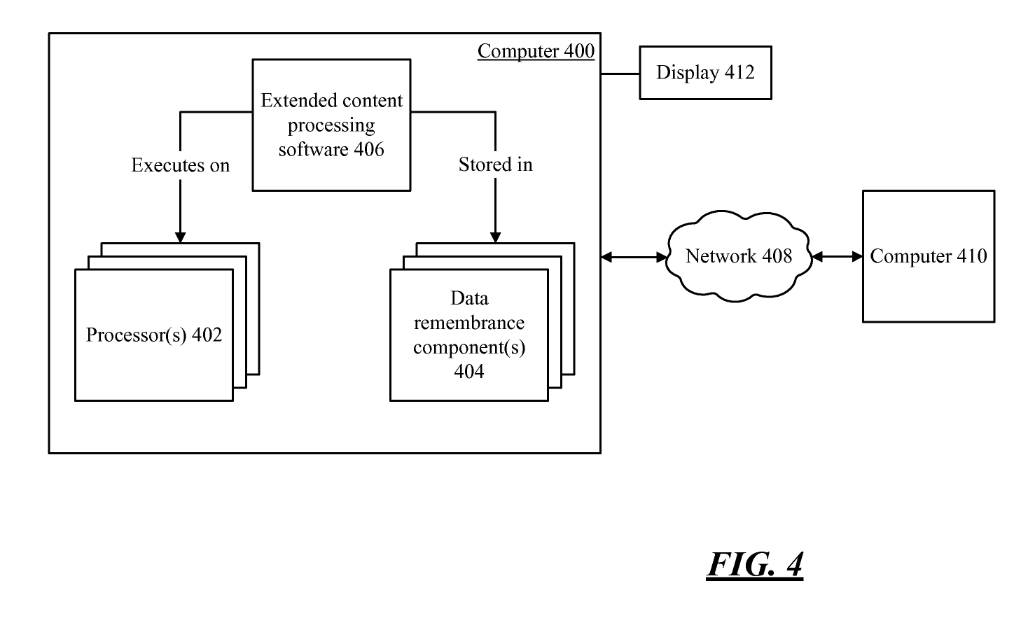

FIG. 4 shows an example environment in which aspects of the subject matter described herein may be deployed.

Computer 400 includes one or more processors 402 and one or more data remembrance components 404. Processor(s) 402 are typically microprocessors, such as those found in a personal desktop or laptop computer, a server, a handheld computer, or another kind of computing device. Data remembrance component(s) 404 are components that are capable of storing data for either the short or long term. Examples of data remembrance component(s) 404 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 400 may comprise, or be associated with, display 412, which may be a cathode ray tube (CRT) monitor, a liquid crystal display (LCD) monitor, or any other type of monitor.

Software may be stored in the data remembrance component(s) 404, and may execute on the one or more processor(s) 402. An example of such software is extended content processing software 406, which may implement some or all of the functionality described above in connection with FIGS. 1-3, although any type of software could be used. Software 406 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 4, although the subject matter described herein is not limited to this example.

The subject matter described herein can be implemented as software that is stored in one or more of the data remembrance component(s) 404 and that executes on one or more of the processor(s) 402. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium. It is noted that there is a distinction between media on which signals are “stored” (which may be referred to as “storage media”), and—in contradistinction—media that contain or transmit propagating signals. DVDs, flash memory, magnetic disks, etc., are examples of storage media. On the other hand, wires or fibers on which signals exist ephemerally are examples of transitory signal media.

Additionally, any acts described herein (whether or not shown in a diagram) may be performed by a processor (e.g., one or more of processors 402) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 400 may be communicatively connected to one or more other devices through network 408. Computer 410, which may be similar in structure to computer 400, is an example of a device that can be connected to computer 400, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to perform a method of generating content, wherein the instructions, when executed by a computer, cause the computer to perform acts comprising:
receiving a first specification of content;
receiving a second specification of a content extension;
receiving a request for said content;
performing a content-generation process to generate said content based on said first specification;
applying said content extension to said content to produce extended content, wherein said applying of said content extension operates on data produced by said content-generation process at one or more interaction points in said content-generation process, but does not modify said content-generation process; and
providing said extended content to an entity that requests said content.

2. The one or more computer-readable storage media of claim 1, wherein said second specification of said content extension comprises deployed code that is created to perform an operation on said content.

3. The one or more computer-readable storage media of claim 1, wherein said second specification of said content extension comprises a first set of instructions, wherein an extensibility package is provided by a first entity that performs operations on said content, wherein said operations are specified by instructions, and wherein said first set of instructions is provided by a second entity that is distinct from said first entity.

4. The one or more computer-readable storage media of claim 1, wherein said content extension comprises an extensibility package whose capabilities have been published by a first entity for use by entities other than said first entity, wherein said second specification instructs said extensibility package as to how to modify said content.

5. The one or more computer-readable storage media of claim 1, wherein a manifest file describes how said content extension is to interact with said content-generation process in order to convert said content into said extended content.

6. The one or more computer-readable storage media of claim 1, wherein said acts are performed by a cluster of machines that include a first machine that implements a back-end and a second machine that implements middleware, wherein said content-generation process is performed on said first machine, and wherein said applying is performed on said second machine.

7. The one or more computer-readable storage media of claim 1, wherein said content-generation process is performed in a first environment, and wherein said applying is performed in a second environment from which said first environment is securely isolated.

8. A method of generating content, the method comprising:
using one or more processors to perform acts comprising:
receiving a first description of content;
receiving a second description of a content modification;
receiving a request for said content;
performing a content-generation process to generate said content based on said first description;
applying said content extension to said content to produce extended content, wherein said applying of said content extension operates on data produced by said content-generation process at one or more interaction points in said content-generation process, but does not modify said content-generation process; and
providing said extended content to front-end servers that serve content to requesting entities.

9. The method of claim 8, wherein said second description of said content extension comprises deployed code that is created to perform an operation on said content.

10. The method of claim 8, wherein said second description of said content extension comprises a first set of instructions, wherein an extensibility package is provided by a first entity that performs operations on said content, wherein said operations are specified by instructions, and wherein said first set of instructions is provided by a second entity that is distinct from said first entity.

11. The method of claim 8, wherein said content extension comprises an extensibility package whose capabilities have been published by a first entity for use by entities other than said first entity, wherein said second description instructs said extensibility package as to how to modify said content.

12. The method of claim 8, wherein a manifest file describes how said content extension is to interact with said content-generation process in order to convert said content into said extended content.

13. The method of claim 8, wherein said acts are performed by a cluster of machines that include a first machine that implements a back-end and a second machine that implements middleware, wherein said content-generation process is performed on said first machine, and wherein said applying is performed on said second machine.

14. The method of claim 8, wherein said content-generation process is performed in a first environment, and wherein said applying is performed in a second environment from which said first environment is securely isolated.

15. A system for generating content, the system comprising:
a memory;
a processor;
a data store that stores a first specification of content; and
a content-processing engine that receives said first specification of said content, a second specification of a content extension, and a request for said content, that performs a content-generation process to generate said content based on said first specification, and that applies said content extension to said content to produce extended content by operating on data produced by said content-generation process at one or more interaction points in said content-generation process without modifying said content-generation process, wherein said content-processing engine provides said extended content to an entity that requests said content.

16. The system of claim 15, wherein said second specification of said content extension comprises deployed code that is created to perform an operation on said content, wherein said code executes outside of said content-processing engine.

17. The system of claim 15, further comprising:
an extensibility package that is stored in said data store and that is provided by a first entity, wherein said extensibility package performs operations on said content that are specified by instructions,
wherein said second specification of said content extension comprises a first set of instructions that is provided by a second entity that is distinct from said first entity.

18. The system of claim 15, wherein said content extension comprises an extensibility package that is stored in said data store and whose capabilities have been published by a first entity for use by entities other than said first entity, wherein said second specification instructs said extensibility package as to how to modify said content.

19. The system of claim 15, further comprising:
a manifest file that is stored in said data store and that describes how said content extension is to interact with said content-generation process in order to convert said content into said extended content.

20. The system of claim 15, wherein said content-processing engine provides a first environment in which said content-generation process is performed, and further provides a second environment, which is securely isolated from said first environment, said content extension being applied to said content in said second environment.
